(19) United States
(12) Patent Application Publication
(10) Pub. No.: US 2020/0296899 A1
(43) Pub. Date: Sep. 24, 2020

(54) SYSTEM FOR PROTECTED GROW BED

(71) Applicant: Nelson and Pade, Inc., Montello, WI (US)

(72) Inventor: John Pade, Montello, WI (US)

(21) Appl. No.: 16/826,526

(22) Filed: Mar. 23, 2020

Related U.S. Application Data
(60) Provisional application No. 62/821,550, filed on Mar. 21, 2019.

(51) Int. Cl. A01G 7/04; A01G 9/20; A01G 9/24; A01G 25/16; A01G 27/02

(52) U.S. Cl. CPC A01G 7/045; A01G 9/20; A01G 27/02; A01G 25/16; A01G 9/247

(57) ABSTRACT

A self-contained apparatus for protected agriculture The apparatus includes a tank, framing connected to the tank including uprights and trusses, a light rack movably positioned between the tank and the trusses, and a drive system connected to the framing and the light rack. The drive system is dimensioned and configured to move the light rack to different positions between the tank and the trusses.

### CROSS-REFERENCE TO RELATED APPLICATIONS

Priority is hereby claimed to provisional application Ser. No. 62/821,550, filed Mar. 21, 2019, which is incorporated herein by reference.

### BACKGROUND

The present disclosure is directed to a system for protected agricultural systems, and more specifically to an easily erected system for protecting hydroponics, aquaponics, and aquaculture systems.

Arable land and potable water are diminishing commodities. The world's population is growing approximately 1.1% annually while quality fertile and tillable land is decreasing due to pollution, soil nutrient exhaustion, lack of irrigation, poor cultivation techniques, expansion of human habitation, and industrial activity. It may not be possible to reclaim contaminated land in reasonable time frames. Water supplies available for agriculture are likewise limited. Similarly, areas with large populations are more likely to have limited and polluted potable water supplies. The world is drawing nearer to the point where the plant- and animal-based food requirements of the human population exceed the capacity of available arable land to generate the required amount of food.

Solutions to this issue include aquaculture and hydroculture. In both methods, food is cultivated in controlled aquatic environments. When efficiently implemented, hydroculture is roughly 10-fold more efficient than traditional farming in terms of land use. It also uses approximately 13-fold less water per crop cycle than traditional farming. Aquatic food cultivation also allows continuous cultivation in protected areas, better control over the growing environment, and can be implemented in areas not otherwise available to agriculture. Aquaculture and hydroculture systems may be located, for example, in residential urban areas, on rooftops, on heavily contaminated land, and in repurposed industrial areas.

Unfortunately, vermin and existing environmental contaminants can make their way into improperly protected aquaculture and hydroculture systems. Providing effective protection may make systems so bulky, expensive, and difficult to construct that they are unfeasible for moderate- to large-scale operations. The systems themselves may require individual control systems which require extensive labor for large-scale monocultures. Conversely a system with many varied plants may also require extensive labor for each individual culture. Tie points for mounting grow lights may be difficult to access, too far away for effective light delivery, or otherwise unsuitable.

A solution is needed that allows for easy setup and modularity, maintains clean cultivating conditions, and ensures effective light delivery.

### SUMMARY

Disclosed and claimed herein is a self-contained apparatus for protected agriculture, A first version of the apparatus comprises a tank. The tank itself includes a tank frame and a tank liner at least partially covering the tank frame. Framing is connected to the tank. The framing comprising a plurality of framing uprights (studs) extending upwardly from the tank and at least one truss connected at least two of the plurality of framing uprights. A movable light rack with grow lights attached is positioned between the tank and the trusses. The light rack is moved using a drive system connected to the framing and the light rack. The drive system is dimensioned and configured to move the light rack to different positions between the tank and the trusses. In this fashion, the intensity and amount of light reaching a growing crop can be adjusted (either manually or automatically).

In one version of the apparatus, the drive system comprises a drive upright positioned substantially parallel to the framing uprights, a drive arm attached to the drive upright such that the drive arm is substantially parallel to the at least one truss, and a drive unit connected to the drive upright or the drive arm and operationally connected to the light rack. The drive unit is dimensioned and configured to move the light rack up and down between the top surface of the tank and the plane defied by the lower edges of the trusses. The drive system may, if desired, be integrated into the framing uprights and the trusses. The drive unit may be connected to the light rack, for example, via one or more cables, a drive shaft, or a drive chain (or any combination thereof).

In another version of the apparatus, there are inlet and outlet apertures defined in the tank. Irrigation conduit disposed within the tank is operationally connected to the inlet aperture and dimensioned and configured to dispense water into the tank. This can be done via perforations in the irrigation conduit or metered valves or nozzles to control the amount of water dispensed into the tank. The water dispensed into the tank from the irrigation conduit exits the tank via the outlet aperture and is stored in a water storage unit. The water storage unit is operationally connected to both the outlet aperture and the inlet aperture. This creates a recirculation circuit: water is pumped from the water storage unit to the irrigation conduit via the inlet aperture. Water then exits the irrigation conduit and enters the tank, where it is accessible to plants (or fish) growing within the tank. Water exits the tank via the outlet aperture and re-enters the water storage unit to begin the cycle anew. In this version, the apparatus includes a pump operationally connected to the inlet, the outlet, and the water storage unit. The pump is dimensioned and configured to move water from the water storage unit to the irrigation conduit. Optionally, a temperature control unit is operationally connected to the water storage unit at any point in the recirculation circuit to keep the water within a desired temperature range.

In another version, the apparatus comprises:

a tank comprising a tank frame and a tank liner at least partially covering the tank frame, and an inlet aperture and an outlet aperture defined in the tank;

framing connected to the tank, the framing comprising a plurality of framing uprights extending from the tank and at least one truss connected at least two of the plurality of framing uprights;

a light rack movably positioned between the tank the at least one truss;

a grow light connected to the light rack;

a drive system connected to the framing and operationally connected to the light rack, wherein the drive system is dimensioned and configured to move the light rack to different positions between the tank and the at least one truss, wherein the drive system comprises:
a drive upright positioned substantially parallel to the framing uprights;
a drive arm attached to the drive upright such that the drive arm is substantially parallel to the at least one truss;
a drive unit connected to the drive upright or the drive arm and operationally connected to the light rack, wherein the drive unit is dimensioned and configured to move the light rack;

irrigation conduit disposed within the tank and operationally connected to the inlet aperture and dimensioned and configured to dispense water into the tank;

a water storage unit operationally connected to the outlet aperture and the inlet aperture;

a pump operationally connected to the inlet, the outlet, and the water storage unit, wherein the pump is dimensioned and configured to move water from the water storage unit to the irrigation conduit;

a temperature control unit operationally connected to the water storage unit;

at least one control valve operationally connected to the irrigation conduit;

at least one sensor dimensioned and configured to measure water temperature within the water storage unit and water flow through the inlet aperture;

a system controller operationally connected to the pump, the temperature control unit, the at least one control valve; and the at least one sensor, wherein the system controller is dimensioned and configured to maintain water temperature and water flow rate through the irrigation conduit within user-defined ranges;

a water processor operationally connected to the outlet aperture and the water storage unit, downstream of the outlet aperture and upstream of the water storage unit, wherein the water processor is dimensioned and configured to remove impurities from water exiting the tank through the outlet aperture and prior to the water entering the water storage unit; and

an ionization unit operationally connected to the outlet aperture and the water storage unit, downstream of the outlet aperture and upstream of the water storage unit. wherein the ionization unit is dimensioned and configured to ionize impurities from water exiting the tank through the outlet aperture and prior to the water entering the water storage unit.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

Several elements of the apparatus are defined in the specification and claims using the word “water,” such as the “water storage unit,” the “water pump,” the “water processor,” etc. In these contexts, the word “water” is synonymous with “liquid.” The reference to “water” is simply for brevity. Any liquid can be used.

All references to singular characteristics or limitations of the present invention shall include the corresponding plural characteristic or limitation, and vice-versa, unless otherwise specified or clearly implied to the contrary by the context in which the reference is made. The indefinite articles “a” and “an” are explicitly defined herein to mean “one or more” or “at least one” unless explicitly stated to the contrary.

All combinations of method or process steps as used herein can be performed in any order, unless otherwise specified or clearly implied to the contrary by the context in which the referenced combination is made.

The apparatus and methods described herein can comprise, consist of, or consist essentially of the essential elements and limitations disclosed herein, as well as any additional or optional ingredients, components, or limitations described herein or otherwise useful in hydroponics, aquaponics, or other methods of controlled-environment agriculture.

### BRIEF DESCRIPTION OF THE DRAWING(S)

FIG. 1 depicts an exemplary version of a hydroponic, aquaponic, or aquatic cultivation system.

FIGS. 2a, 2b, 2c, 2d, 2e, 2f, 2g, and 2h depict the various construction stages of an exemplary version of the hydroponic, aquaponic, or aquatic cultivation system.

FIG. 3 depicts a system diagram of an exemplary version of the hydroponic, aquaponic, or aquatic cultivation system.

FIG. 4 depicts a system diagram of an exemplary version of system using multiple hydroponic, aquaponic, or aquatic cultivation systems.

FIG. 5 depicts a system diagram of an exemplary version of a controller for the hydroponic, aquaponic, or aquatic cultivation system.

For clarity, not every part is labeled or reproduced in every possible instance or for every drawing. Lack of labeling or reproduction should not be interpreted as a lack of disclosure.

### DETAILED DESCRIPTION

In the present description, certain terms have been used for solely for brevity and clarity. The terms are used for descriptive purposes only and are intended to be broadly construed. The different systems and methods described herein may be used alone or in combination with other systems and methods. Various equivalents, alternatives and modifications are possible within the scope of appended claims. Any limitation in an appended claim is intended to invoke interpretation under 35 U. S. C. § 112, sixth paragraph, only if the terms “means for” or “step for” are explicitly recited in the respective limitation.

The present cultivation system 100 is ideal for aquaponics, hydroponics, and any other agricultural methods that use organic or traditional soil methodologies. The system 100 is easy to assemble. The system requires very few tools for assembly. The system does not require any special construction knowledge or skills to erect. The system 100 includes the frame structure, adjustable light racking, grow bed liners, pads, and plumbing inlets and outlets, The system 100 is self-supporting. It can be set on a suitable flat floor or supporting pad (of conventional construction) without additional support needed. One frame is dimensioned and configured to support the plant grow beds, adjustable lighting, and protective covering. The bottom portion is the grow bed. The next layer is the adjustable light rack so that a grower can adjust the height of the grow lights from the plants to follow the growth of the crop. The system 100 incorporates an adjustable light rack into the grow bed frame and a structure that can be used to provide weather protection, shading, black out, and biosecurity. The auto track light support provides adjustable height for moving lights up and down to follow the growth of the plants. The frame itself can be dimensioned and configured to support different kinds of covering (e.g., clear or tinted, flexible plastic sheeting, flexible woven sheeting, stiff polymer or glass panels, etc. In short, the versatile frame structure provides support for coverings such as, but not limited to, blackout shades, shade cloths, insect screening, bird netting, and all-weather coverings, whether clear, shading, or insulated.

The system 100 makes indoor growing easy, safe and secure with no requirement to attach grow lights to the building itself and can protect the crop from debris or other contaminants within an existing building. Installing one integrated frame for the grow bed, lights and covering simplifies the installation, saves money and provides more versatility, better plant growth, and biosecurity. There is no other product like this that incorporates the grow bed frame, light rack, and structure. A grower can assemble this in hours, not weeks. Users can add additional systems 100 via the plumbing connections; due to the modularity of system 100, it may be combined with other systems 100, or different types of external systems.

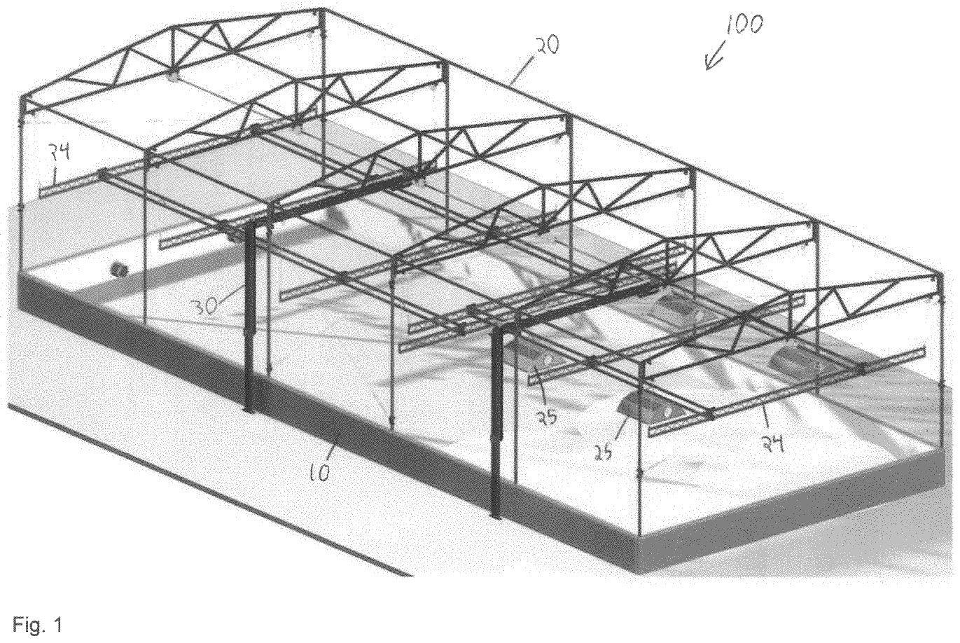

As can be seen in FIG. 1, the system 100 includes at least one tank 10 combined with framing 20. At least one driver/drive system 30 is connected to framing 20 to allow movement of at least one light rack 24 carrying grow lights 25. As required for strength, ease of assembly, and ultimate utility, portions of tank 10 and framing 20 may be of metallic or polymeric components suitable for exposure to water and concomitant use in agriculture. At least one covering (not shown) may be draped over or otherwise connected to framing 20. The covering may range in transparency from completely transparent to completely opaque; certain embodiments may be selectively transparent or opaque to certain wavelengths. The covering may range in flexibility from completely flexible to completely rigid. The covering may be capable of varying levels of gas- or liquid-permeability. Various portions of the same covering may differ in transparency, flexibility, and/or permeability. The covering may be perforated or comprise a mesh in certain areas. The covering may have slits or other openings, or partially or fully removable panels to facilitate access to the interior of system 100.

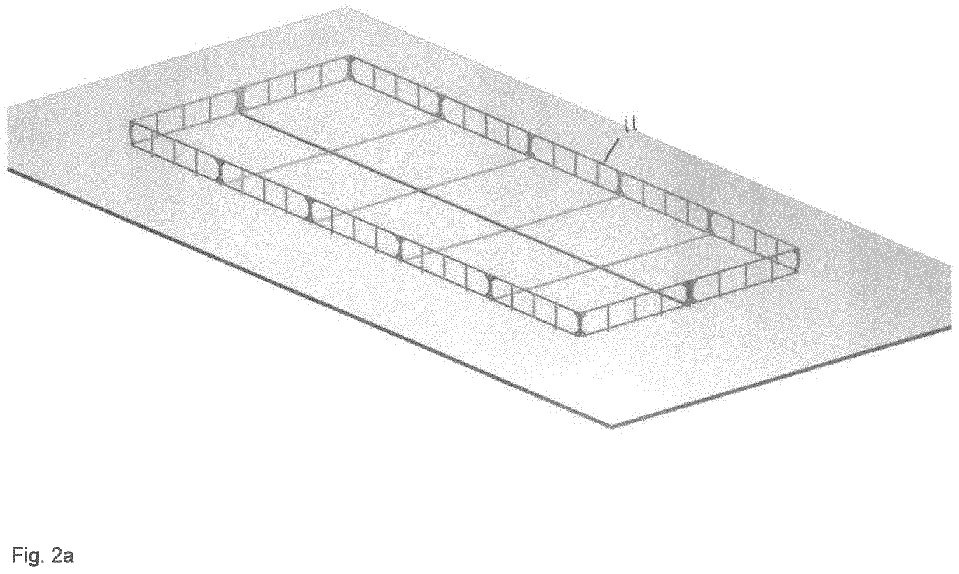

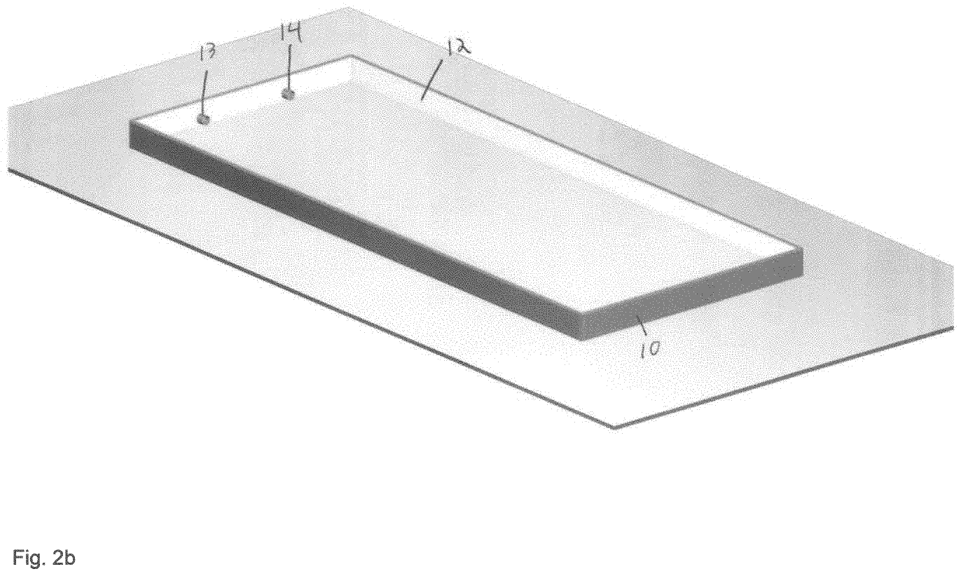

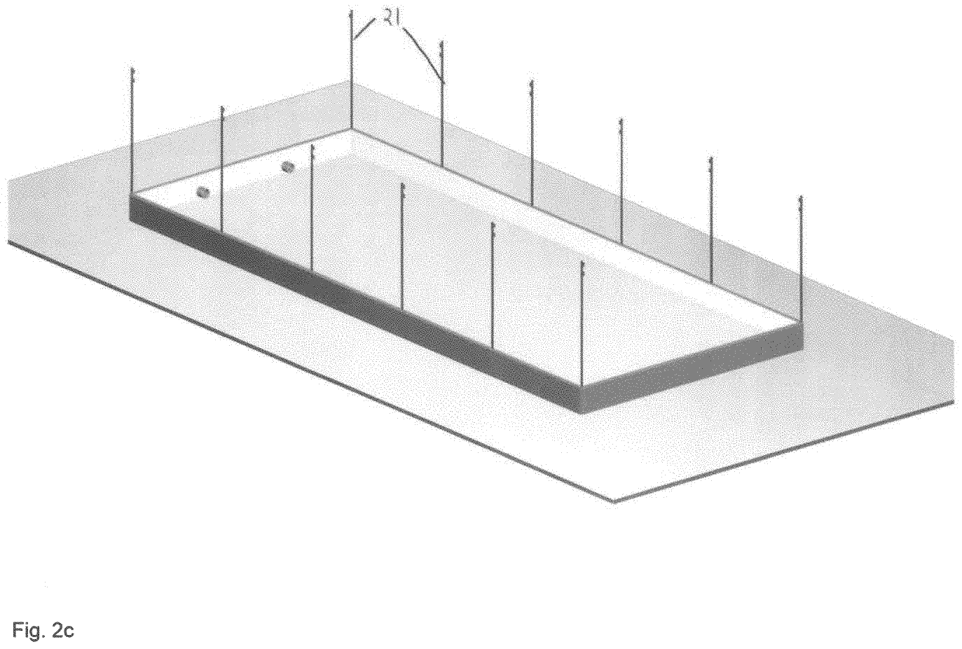

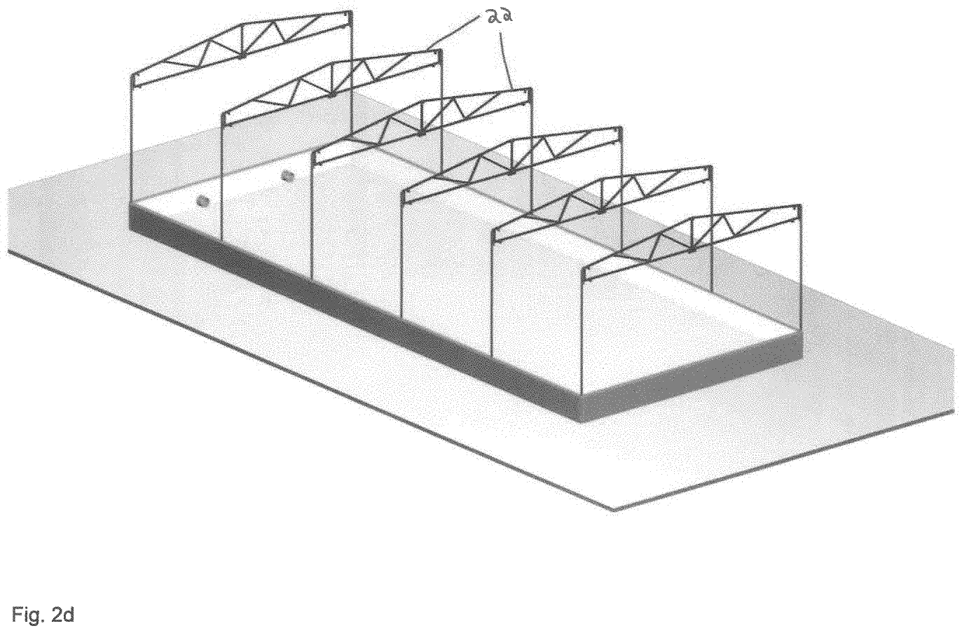

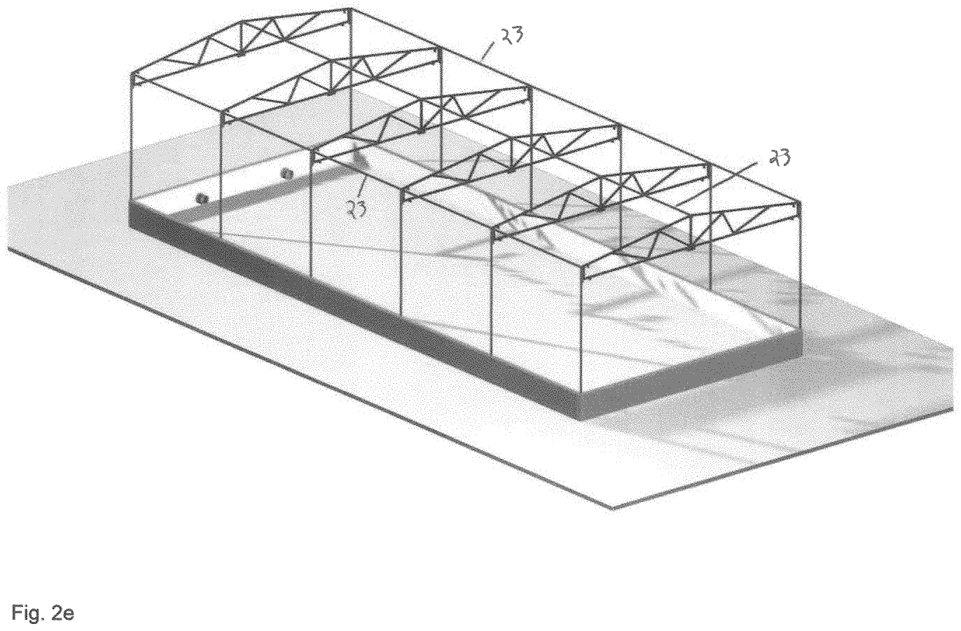

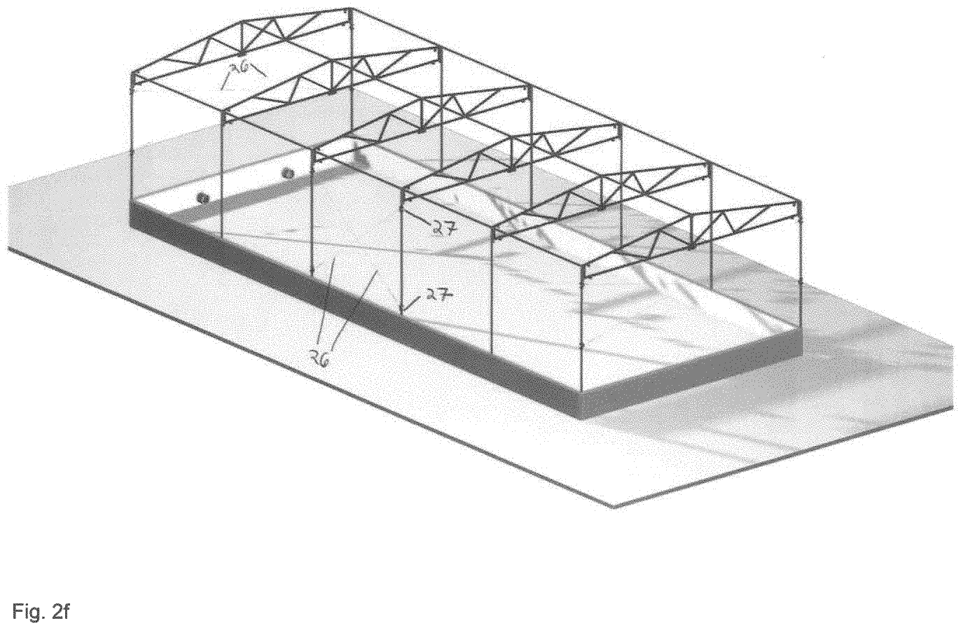

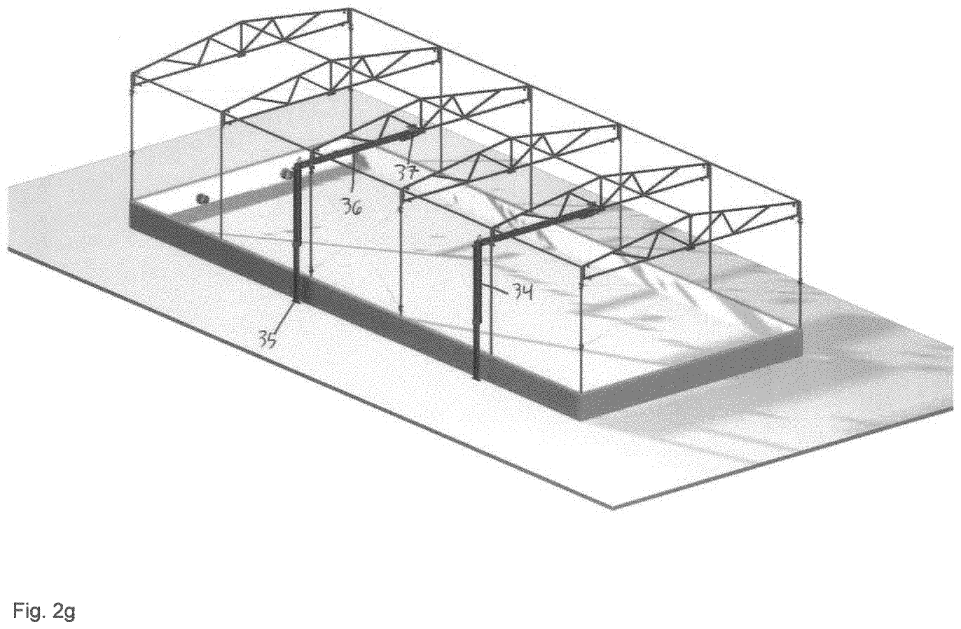

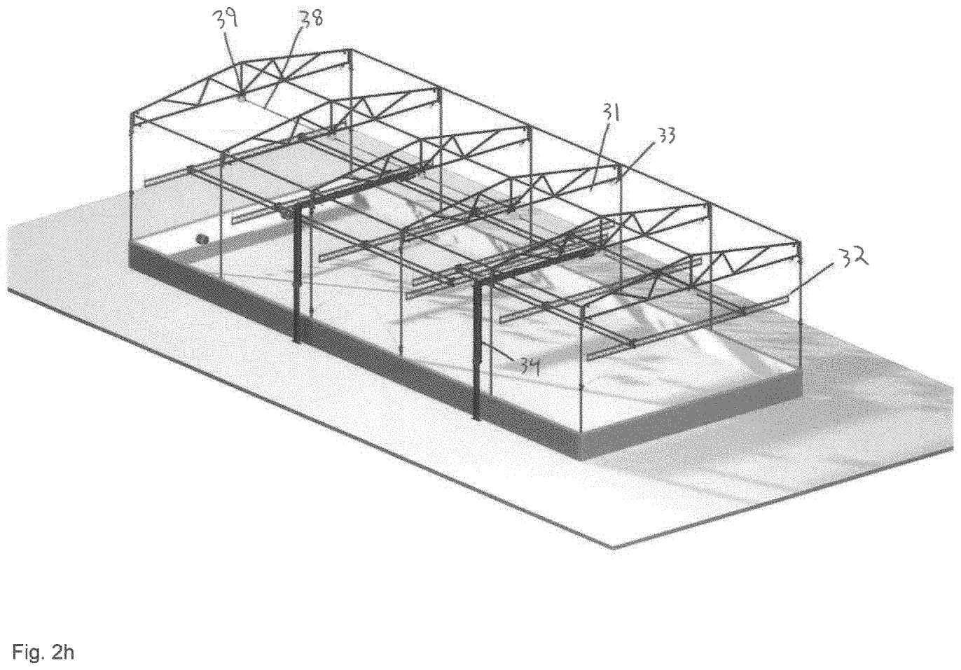

As seen in FIG. 1, tank 10 includes a base surrounded by a plurality of sidewalls extending upwardly therefrom. While the embodiment shown in FIG. 1 is rectangular in configuration, it is anticipated that tank 10 may take any polygonal or compound polygonal configuration which may be used in aquaculture and/or hydroculture. The tank 10 is supported by a structured tank frame 11, as seen in FIG. 2a. The tank frame 11 may rise up to four feet from a supporting floor and is capable of supporting the weight of a substance completely filling tank 10, such as, but not limited to, water, soil, saturated soil, or any other substance used in system 100.

A tank liner 12 covers at least the interior of tank frame 11. In the embodiment shown in FIG. 2b, tank liner 12 covers both the interior and exterior of tank frame 11, The tank liner 12 is at least one liquid- and/or gas-impermeable membrane with limited to full flexibility. In certain embodiments, tank liner 12 may comprise multiple layers or multiple sealably connected but separable sections. In certain embodiments, at least one layer of padding may be placed between elements of tank frame 11 and/or between tank frame 11 and tank liner 12 to prevent damage to tank liner 12 and provide additional strength, insulation, and/or puncture resistance to tank 10. In certain embodiments, at least one pipe inlet 13 and/or pipe outlet 14 extends through at least one sidewall of tank 10 to allow passage of fluids to and/or from tank 10 during use. The pipe inlet 13 and/or pipe outlet 14 may be permanently or removably connected to one or more fluid conduits. The pipe inlet 13 and/or pipe outlet 14 may be outfitted with closures and/or non-return valves to allow detachment from fluid conduits or other systems 100, and to prevent reversed flow.

The tank 10 supports framing 20, The framing 20 includes truss uprights 21 connected to tank frame 11. As can be seen in FIG. 2c, the truss uprights 21 extend vertically from at least two parallel sidewalls of tank 10. Each pair of truss uprights 21 are connected at their upper ends by a truss 22 extending over tank 10, as shown in FIG. 2d. In the embodiment shown in FIG. 2d, trusses 22 are planar trusses, though other truss configurations are contemplated.

As can be seen in FIG. 2e, the trusses 22 in the exemplary version are connected by at least two purlins 23, which extend parallel to each other and the base of tank 10, and orthogonally to truss uprights 21. The number of purlins is dictated principally by the overall size of the structure and also by the material to be used as the roof decking. In the embodiment shown in FIG. 2e, three purlins 23 connect trusses 22 along their upper ends, though other attachment points, Any number of purlins may be used, including no purlins. The truss uprights 21, trusses 22, and/or purlins 23 may have a solid cross-section, closed hollow cross-section, open hollow cross-section, and/or any combination thereof. Connections between truss uprights 21, trusses 22, and/or purlins 23 may be made through welding, soldering, adhesives, interlocking components, “slot and tab/mortise and tenon”-type insertion, the use of anchors such as, but not limited to, pins, dowels, screws, and/or bolts, and any other connection means known in the art, and/or any combination thereof.

As can be seen in FIG. 2f, certain embodiments may include additional structural reinforcement in the form of supporting cables 26, The supporting cables 26 may extend between any of the truss uprights 21, trusses 22, and/or purlins 23 to reinforce structural integrity. The supporting cables 26 are fastened to supporting cable anchors 27 attached to truss uprights 21, trusses 22, and/or purlins 23. In certain embodiments, structural cables 26 may be attached to supporting cable anchors 27 located outside of system 100. Such supporting cable anchors 27 may be connected to external points such as, but not limited to, the ground, surrounding environmental or architectural features, other systems 100, and/or combinations thereof.

Additional components of framing 20 are installed in conjunction with driver/drive system 30. As can be seen in FIGS. 2g and 2h, drive system 30 includes multiple drive cables 31 attached on at least one end to drive cable anchors 32 on truss uprights 21, trusses 22, purlins 23, light racks 24, and/or grow lights 25. The drive cables 31 extend through cable pulleys 33 on truss uprights 21, trusses 22, purlins 23, and/or light racks 24. The drive cables 31 may be a coated or uncoated metal, natural fiber, polymer and/or any combination thereof.

Drive power may be provided within system 100 by at least one drive unit 34 extending along at least one drive upright 35. The drive unit 34 may run along a drive arm 36 extending orthogonally from drive upright 35 over tank 10. In the exemplary embodiment, drive unit 34 is a chain drive, though other drives such as, but not limited to, a worm drive or belt drive are contemplated. In the exemplary embodiment, at least one gear box 37 at the end of drive unit 34 translates the drive unit motion into rotation of at least one drive shaft 38 extending at least partially along the length of system 100 and connected to at least one drive cable 31. The drive shaft 38 is supported by at least one drive shaft bearing 39. Rotation of drive shaft 38 spools or unspools drive cables 31 depending on the direction of the rotation, causing movement of light racks 24 and/or grow lights 25, based on the configuration of drive cables 31, drive cable anchors 32, and/or cable pulleys 33. Depending on such configurations, light racks 24 and/or grow lights 25 may move horizontally, vertically, rotationally, and/or any combination thereof.

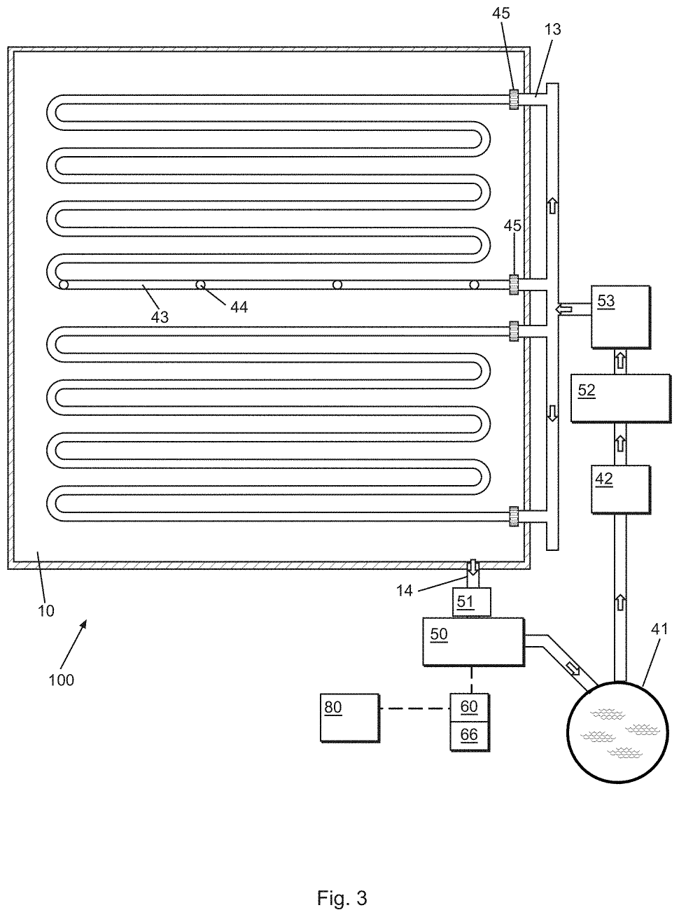

As can be seen in FIG. 3, in certain embodiments, another component of system 100 is an irrigation system 40 which may provide water for cultivation. Such an irrigation system 40 may be added after assembly of tank 10, framing 20, and drive system 30, or be an integral part of system 100. The irrigation system may include at least one water storage unit 41, water pump 42, irrigation conduit 43 providing water to dispensing nozzles 44, and control valves 45.

In certain embodiments, system 100 includes at least one water processor 50, which removes and/or breaks down chemical, biological, and/or particulate contaminants in water received via pipe outlet 14, such as, but not limited to, bacteria and other microorganisms, agrochemicals, salts, and/or biological waste. In certain embodiments, water processor 50 includes or is in line with an ionization unit 51 to provide ozone- and hydroxide-ionization assisted breakdown of contaminants. The water processor 50 may be a high-volume water cleaning unit.

The water processor 50 may utilize water processing methodologies such as, but not limited to, deionization, biological water treatment (with or without media filtration), ozonation, hydroxide (OH⁻) dosing, water softening, distillation and vapor distillation, ultraviolet radiation, electrostatic water treatment, flocculation, filtration, and any combination thereof. The water processor 50 may utilize filtration methodologies such as, but not limited to, reverse osmosis filtration, sediment filtration, sand filtration, filtration with commercially available media (such as, but not limited to, Kinetic Degradation Fluxion redox filtration media, Aqua Treatment Services filters, etc.), activated carbon filtration, nanoscale or graphene membrane filtration, electrodialysis, filtration with activated alumina (Al₂O₃), and any combination thereof. The water processor 50 may utilize sediment removal methodologies such as, but not limited to, weirs, centrifugal separation, gravity separators, coarse membranes or media with backwashing, Y strainers, spin down strainers, and any combination thereof.

In line with pipe inlet 13, at least one additive unit 52 may provide additives that assist in plant or animal cultivation, such as, but not limited to, fertilizers and feed. Such additives may be added using, by way of non-limiting example, metering pumps, venturi pumps, line injection, various mixing and/or blowing processes, and any combination thereof. At least one temperature control unit 53 may increase the water temperature to heat system 100, which may be used to offset non-optimal environmental temperatures. The temperature control unit 53 is a liquid temperature control such as, but not limited to, a thin film heater, a ceramic heater, a resistive heater, a solar heater, a geothermal heat pump, a fossil fuel-based heater, a friction heater, a thermo-electric heater, and any combination thereof. The temperature control unit 53 my also include a chiller if the incoming water is too warm. Additional and/or duplicative treatment units in any combination may be added to utilize any of the above treatment, water processing, sediment removal, and/or filtration methodologies.

The system 100 may be controlled by at least one system controller 60. The system controller 60 may control various components of system 100, such as, but not limited to, grow lights 25, drive unit 34, irrigation system 40, water processor 50, ionization unit 51 additive unit 52, and/or temperature control unit 53. The system controller 60 may allow automatic and/or manual monitoring of the cultivated plants or animals, the system 100, or any system component through at least one sensor 70. The sensor 70 may monitor height of crops, location of system components, moisture content of the air or soil, light, chemicals present, temperature, pressure, flow, and/or any combination thereof. These sensors 70 may be integrated into system components and/or removably connected to system components.

Data collected from the various system components may be stored on controller data storage 66. In one embodiment, controller data storage 66 is cloud storage. The system controller 60 may be connected via a wired and/or wireless connection to any of the components of system 100. The system controller 60 may receive status updates, system feedback, sensor data, and user input, transmit control signals and output data to users and controller data storage 66, and automatically calculate adjustments required to any part of system 100 to maintain a given level of operations or follow a growth plan.

The system controller 60 may directly control system components or may send commands to sub-controllers regulating individual components or groups of components. Embodiments for very large operations may use multiple controllers 60 operating independently or slaved to at least one master controller 90, which functions similarly to controller 60, but with increased storage and processing power to allow control over a more complex set of systems 100. The controller 60 may completely automate all aspects of regulating system 100, require manual input of all controlling factors, or provide limited automation with user setup, manual intervention, and/or user approval required for certain exceptions.

The system controller 60 may use operational profiles 80 including differing operational parameters. Operational parameters are the system and/or component commands and/or settings necessary for cultivation. Operational profiles 80 may have completely pre-set parameters, have some customizable parameters, or require user input of all parameters. Parameters may be based on types of plants or animals cultivated, harvest stage, soil types, environmental configurations, drainage, existing or available system components, any other required or optional variables, and any combinations thereof.

By way of non-limiting examples, the operational profile 80 for hydroculture of lettuce in a cool, arid warehouse environment may be different from an operational profile 80 for aquaculture of shrimp on a rooftop in a warm, humid environment. The operational profile 80 for hydroculture of a crop may be different from an operational profile 80 for soil-based culture of the same crop. The operational profile 80 for large-scale, multi-system 100 growth of leafy greens may be different from an operational profile 80 used to grow multiple leafy green and legume crops in a single system 100. The operational profile 80 for cultivating a single fish species for human consumption may be different from an operational profile 80 for cultivating multiple fish species as a feedstock.

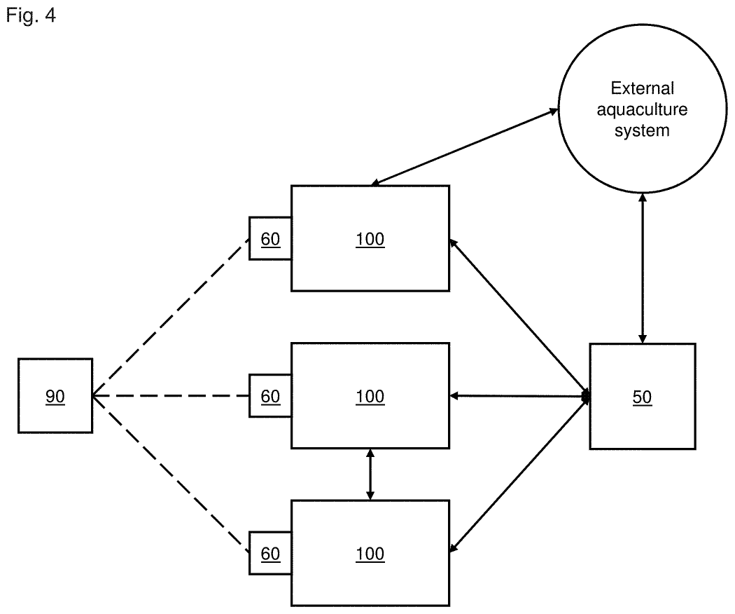

As can be seen in FIG. 4, certain embodiments may link multiple systems 100 and/or include other external systems. In such cases, master controller 90 may interconnect the systems, multiple system controllers 60, and/or any other system components. Furthermore, certain components, such as, but not limited to, water processor 50, may not be duplicated amongst multiple systems 100.

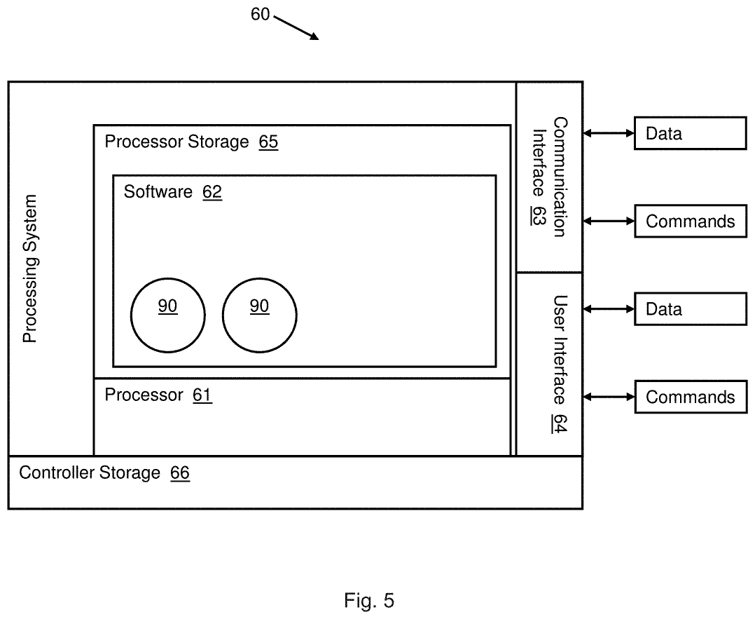

FIG. 5 depicts an exemplary embodiment of controller 60 in system 100. The controller 60 is generally an independent processing system that includes a processor 61, software 62, a communication interface 63, a user interface 64, a processor storage 65, and a controller data storage 66. The processor 61 loads and executes software 62 from processor storage 65, which may include at least one operational profile 80 containing commands, data values/ranges, and variables for at least one specific type of operation, as detailed above. When executed by controller 60, software 62 directs the processor 61 to operate as described in herein.

The controller 60 includes software 62 for controlling and modifying the functioning of system 100. While the description as provided herein refers to a controller 60 and a processor 61, it is to be recognized that implementations of such controllers can be performed using one or more processors 61, which may be communicatively connected, and such implementations are considered to be within the scope of the description. It is also contemplated that these components of controller 60 may be operating in a number of physical locations.

The processor 61 can comprise a microprocessor and other circuitry that retrieves and executes software 62 from controller data storage 66. The processor 61 can be implemented within a single processing device but can also be distributed across multiple processing devices or sub-systems that cooperate in existing program instructions. Non-limiting examples of processors 61 include general purpose central processing units, application specific processors, and logic devices, as well as any other type of processing device, combinations of processing devices, or variations thereof.

The controller data storage 66 can comprise any storage media readable by processor 61, and capable of storing software 62. The controller data storage 66 can include volatile and non-volatile, removable and non-removable media implemented in any method or technology for storage of information, such as, but not limited to, computer readable instructions, data structures, program modules, or other information. The controller data storage 66 can be implemented as a single storage device but may also be implemented across multiple storage devices or sub-systems. The controller data storage 66 can further include additional elements, such a controller capable of communicating with the processor 61.

Non-limiting examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 100.

As described in further detail herein, controller 60 receives and transmits data through communication interface 63. The data can include data from sensors 70, data to be recorded by controller data storage 66, and/or data received from user interface 64. In embodiments, the communication interface 63 also operates to process data prior to sending and/or after receiving the data. Data processing can include packetization, digitization, format conversion, encryption, and/or the reverse of such processes.

The user interface 64 can include one or more input devices such as, but not limited to, a mouse, a keyboard or keypad, a voice input device, a touch input device for receiving a gesture from a user, a motion input device for detecting non-touch gestures and other motions by a user, and/or other comparable input devices and associated processing elements capable of receiving user input from a user. Output devices such as, but not limited to, a video display or graphical display can display data or current status of system components. Speakers, printers, haptic devices and other types of output devices may also be included in the user interface 64. Users can communicate with controller 60 through the user interface 64 in order to enter or receive data, set initial parameters, set stop parameters, or any number of other tasks the user may want to complete with controller 60.

In the foregoing description, certain terms have been used for brevity, clearness, and understanding. No unnecessary limitations are to be inferred therefrom beyond the requirement of the prior art because such terms are used for descriptive purposes and are intended to be broadly construed. Any different configurations, systems, and method steps described herein may be used alone or in combination with other configurations, systems, and method steps.

It is to be understood that the following claims are exemplary in nature only, and do not place and should not be interpreted to place any limitations on any claims in any subsequent applications whatsoever.

What is claimed is:

1. A self-contained apparatus for protected agriculture, the apparatus comprising:
a tank comprising a tank frame and a tank liner at least partially covering the tank frame;
framing connected to the tank, the framing comprising a plurality of framing uprights extending from the tank and at least one truss connected at least two of the plurality of framing uprights;
a light rack movably positioned between the tank and the at least one truss;
a drive system connected to the framing and operationally connected to the light rack, wherein the drive system is dimensioned and configured to move the light rack to different positions between the tank and the at least one truss.

2. The self-contained apparatus of claim 1, wherein the drive system comprises:
a drive upright positioned substantially parallel to the framing uprights;
a drive arm attached to the drive upright such that the drive arm is substantially parallel to the at least one truss;
a drive unit connected to the drive upright or the drive arm and operationally connected to the light rack, wherein the drive unit is dimensioned and configured to move the light rack.

3. The self-contained apparatus of claim 2, wherein the drive unit is operationally connected to the light rack via a cable.

4. The self-contained apparatus of claim 2, wherein the drive unit is operationally connected to the light rack via a drive shaft.

5. The self-contained apparatus of claim 2, wherein the drive unit is operationally connected to the light rack via a drive chain.

6. The self-contained apparatus of claim 1, further comprising a grow light connected to the light rack.

7. The self-contained apparatus of claim 1, further comprising:
an inlet aperture and an outlet aperture defined in the tank;
irrigation conduit disposed within the tank and operationally connected to the inlet aperture and dimensioned and configured to dispense water into the tank;
a water storage unit operationally connected to the outlet aperture and the inlet aperture;
a pump operationally connected to the inlet, the outlet, and the water storage unit, wherein the pump is dimensioned and configured to move water from the water storage unit to the irrigation conduit; and
a temperature control unit operationally connected to the water storage unit.

8. The self-contained apparatus of claim 7, wherein the drive system comprises:
a drive upright positioned substantially parallel to the framing uprights;
a drive arm attached to the drive upright such that the drive arm is substantially parallel to the at least one truss;
a drive unit connected to the drive upright or the drive arm and operationally connected to the light rack, wherein the drive unit is dimensioned and configured to move the light rack.

9. The self-contained apparatus of claim 8, wherein the drive unit is operationally connected to the light rack via a cable.

10. The self-contained apparatus of claim 8, wherein the drive unit is operationally connected to the light rack via a drive shaft.

11. The self-contained apparatus of claim 8, wherein the drive unit is operationally connected to the light rack via a drive chain.

12. The self-contained apparatus of claim 8, further comprising a grow light connected to the light rack.

13. A self-contained apparatus for protected agriculture, the apparatus comprising:
a tank comprising a tank frame and a tank liner at least partially covering the tank frame, and an inlet aperture and an outlet aperture defined in the tank;
framing connected to the tank, the framing comprising a plurality of framing uprights extending from the tank and at least one truss connected at least two of the plurality of framing uprights;
a light rack movably positioned between the tank and the at least one truss;
a drive system connected to the framing and operationally connected to the light rack, wherein the drive system is dimensioned and configured to move the light rack to different positions between the tank and the at least one truss, wherein the drive system comprises:
a drive upright positioned substantially parallel to the framing uprights;
a drive arm attached to the drive upright such that the drive arm is substantially parallel to the at least one truss;
a drive unit connected to the drive upright or the drive arm and operationally connected to the light rack, wherein the drive unit is dimensioned and configured to move the light rack;
irrigation conduit disposed within the tank and operationally connected to the inlet aperture and dimensioned and configured to dispense water into the tank;
a water storage unit operationally connected to the outlet aperture and the inlet aperture;
a pump operationally connected to the inlet, the outlet, and the water storage unit, wherein the pump is dimensioned and configured to move water from the water storage unit to the irrigation conduit; and
a temperature control unit operationally connected to the water storage unit.

14. The self-contained apparatus of claim 13, wherein the drive unit is operationally connected to the light rack via a cable.

15. The self-contained apparatus of claim 13, wherein the drive unit is operationally connected to the light rack via a drive shaft.

16. The self-contained apparatus of claim 13, wherein the drive unit is operationally connected to the light rack via a drive chain.

17. The self-contained apparatus of claim 13, further comprising a grow light connected to the light rack.

18. A self-contained apparatus for protected agriculture, the apparatus comprising:
a tank comprising a tank frame and a tank liner at least partially covering the tank frame, and an inlet aperture and an outlet aperture defined in the tank;
framing connected to the tank, the framing comprising a plurality of framing uprights extending from the tank and at least one truss connected at least two of the plurality of framing uprights;
a light rack movably positioned between the tank and the at least one truss;
a grow light connected to the light rack;
a drive system connected to the framing and operationally connected to the light rack, wherein the drive system is dimensioned and configured to move the light rack to different positions between the tank and the at least one truss, wherein the drive system comprises:
a drive upright positioned substantially parallel to the framing uprights;
a drive arm attached to the drive upright such that the drive arm is substantially parallel to the at least one truss;
a drive unit connected to the drive upright or the drive arm and operationally connected to the light rack, wherein the drive unit is dimensioned and configured to move the light rack;
irrigation conduit disposed within the tank and operationally connected to the inlet aperture and dimensioned and configured to dispense water into the tank;
a water storage unit operationally connected to the outlet aperture and the inlet aperture;
a pump operationally connected to the inlet, the outlet, and the water storage unit, wherein the pump is dimensioned and configured to move water from the water storage unit to the irrigation conduit;
a temperature control unit operationally connected to the water storage unit;
at least one control valve operationally connected to the irrigation conduit;
at least one sensor dimensioned and configured to measure water temperature within the water storage unit and water flow through the inlet aperture; and
a system controller operationally connected to the pump, the temperature control unit, the at least one control valve; and the at least one sensor, wherein the system controller is dimensioned and configured to maintain water temperature and water flow rate through the irrigation conduit within user-defined ranges.

19. The self-contained apparatus of claim 18, further comprising a water processor operationally connected to the outlet aperture and the water storage unit, downstream of the outlet aperture and upstream of the water storage unit, wherein the water processor is dimensioned and configured to remove impurities from water exiting the tank through the outlet aperture and prior to the water entering the water storage unit.

20. The self-contained apparatus of claim 19, further comprising an ionization unit operationally connected to the outlet aperture and the water storage unit, downstream of the outlet aperture and upstream of the water storage unit. wherein the ionization unit is dimensioned and configured to ionize impurities from water exiting the tank through the outlet aperture and prior to the water entering the water storage unit.
